(19) United States
(12) Patent Application Publication
(10) Pub. No.: US 2025/0267249 A1
(43) Pub. Date: Aug. 21, 2025

(54) IMPROVED DISPLACEMENT CODING

(71) Applicant: TENCENT AMERICA LLC, Palo Alto, CA (US)

(72) Inventors: Thuong NGUYEN CANH, San Bruno, CA (US); Xiaozhong XU, State College, PA (US); Shan LIU, San Jose, CA (US)

(73) Assignee: TENCENT AMERICA LLC, Palo Alto, CA (US)

(21) Appl. No.: 19/048,176

(22) Filed: Feb. 7, 2025

Related U.S. Application Data
(60) Provisional application No. 63/554,415, filed on Feb. 16, 2024.

(51) Int. Cl. H04N 19/105; H04N 19/136; H04N 19/159; H04N 19/50

(52) U.S. Cl. CPC H04N 19/105; H04N 19/136; H04N 19/159; H04N 19/50

(57) ABSTRACT

A method includes receiving a polygon mesh comprising a plurality of vertices; determining, for a vertex from the plurality of vertices at a base level of the polygon mesh, one or more displacements between the vertex and one or more reference vertices from the plurality of vertices; encoding the one or more displacements; and generating a bitstream comprising the one or more encoded displacements and at least one of the one or more reference vertices.

### CROSS-REFERENCE TO RELATED APPLICATION

This application claims priority from U.S. Provisional Application No. 63/554,415 filed on Feb. 16, 2024, the disclosure of which is incorporated herein by reference in its entirety.

### FIELD

This disclosure is directed to a set of advanced video coding technologies. More specifically, the present disclosure is directed to a method and apparatus for displacement coding.

### BACKGROUND

Video-based dynamic mesh coding (V-DMC) is an ongoing MPEG standard to compress dynamic meshes. The current V-DMC reference software compresses meshes based on decimated base meshes, displacements vectors and motion fields. The displacements are calculated by searching the closest point on the input mesh with respect to each vertex of the subdivided based mesh. To encode the displacement, displacement vectors are transformed into wavelet coefficients by a linear lifting scheme, and then the coefficients are quantized and coded by a video codec or arithmetic codec. This process also refines the base mesh to minimize the displacement. Texture transfer may be performed to match the texture with reparameterized geometry and UV as well as optimized texture for image compression.

### SUMMARY

According to an aspect of the disclosure, a method performed by at least one processor of an encoder; the method including receiving a polygon mesh comprising a plurality of vertices; determining, for a vertex from the plurality of vertices at a base level of the polygon mesh, one or more displacements between the vertex and one or more reference vertices from the plurality of vertices; encoding the one or more displacements; and generating a bitstream comprising the one or more encoded displacements and at least one of the one or more reference vertices.

According to an aspect of the disclosure, a method includes receiving a bitstream comprising an encoded polygon mesh comprising a plurality of vertices and one or more encoded displacements; determining an encoded displacement from the one or more encoded displacements; decoding the encoded displacement to generate a decoded displacement; and decoding a vertex from the plurality of vertices at a base level of the polygon mesh using the decoded displacement and one or more reference vertices from the plurality of vertices.

According to an aspect of the disclosure, a method includes generating a bitstream comprising a polygon mesh comprising a plurality of vertices; wherein, for a vertex from the plurality of vertices at a base level of the polygon mesh, one or more displacements between the vertex and one or more reference vertices are determined, wherein the one or more displacements are encoded; and wherein the bitstream comprises the one or more encoded displacements and at least one of the one or more reference vertices.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 illustrates example vertex positions of zero reference vertices (R0), in accordance with embodiments of the present disclosure.

FIG. 5 illustrates example vertex positions for one reference vertex (R1), in accordance with embodiments of the present disclosure.

FIG. 6 illustrates example vertex positions for two reference vertices (R2), in accordance with embodiments of the present disclosure.

FIG. 7 illustrates example vertex positions for three reference vertices (R3), in accordance with embodiments of the present disclosure.

FIG. 8 illustrates example vertex positions for six reference vertices (R6), in accordance with embodiments of the present disclosure.

FIG. 9 is a flowchart of an example process for determining displacements for a vertex.

FIG. 10 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

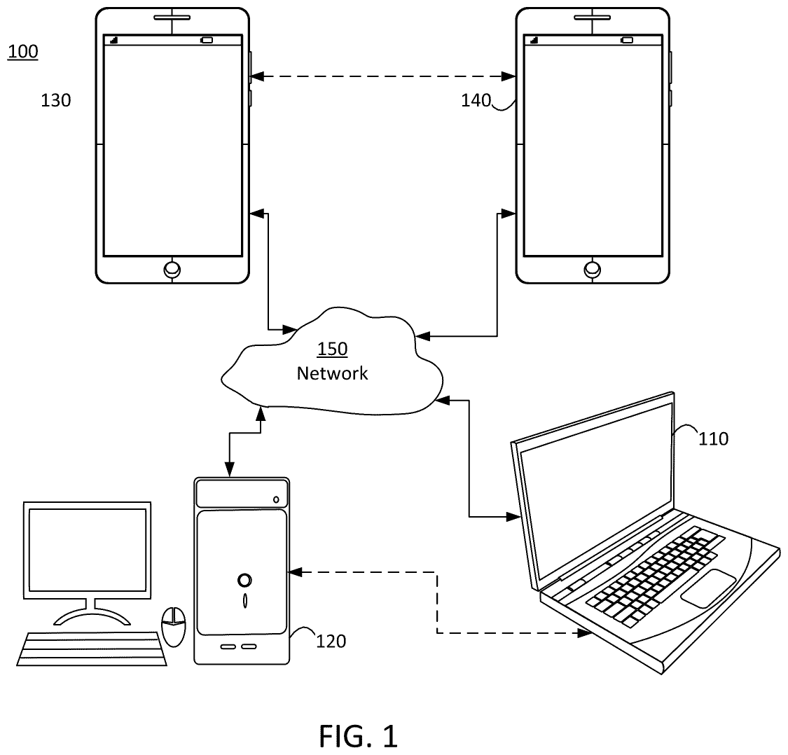

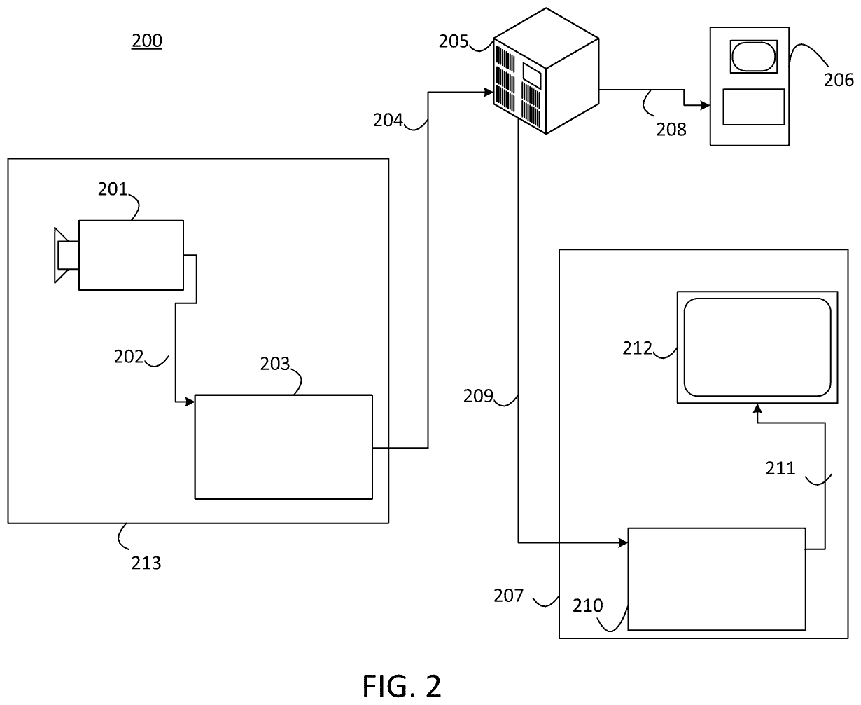

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

Embodiments of the present disclosure directed to a method to encode displacements in lossy mesh coding via lossless mesh coding.

V-DMC is an ongoing MPEG standard to compress dynamic meshes. The current VMesh reference software compresses meshes based on decimated base meshes (encoded by draco), displacements vectors and motion fields (if applicable). The displacements are calculated by searching the closest point on the input mesh with respect to each vertex of the subdivided based mesh. To encode the displacement, displacements vectors are transformed into wavelet coefficients by the linear lifting scheme, and then the coefficients are quantized and coded by a video codec or arithmetic codec. This process also refines the base mesh to minimize the displacement. Texture transfer is performed to match the texture with re-parameterized geometry and UV as well as optimized texture for image compression.

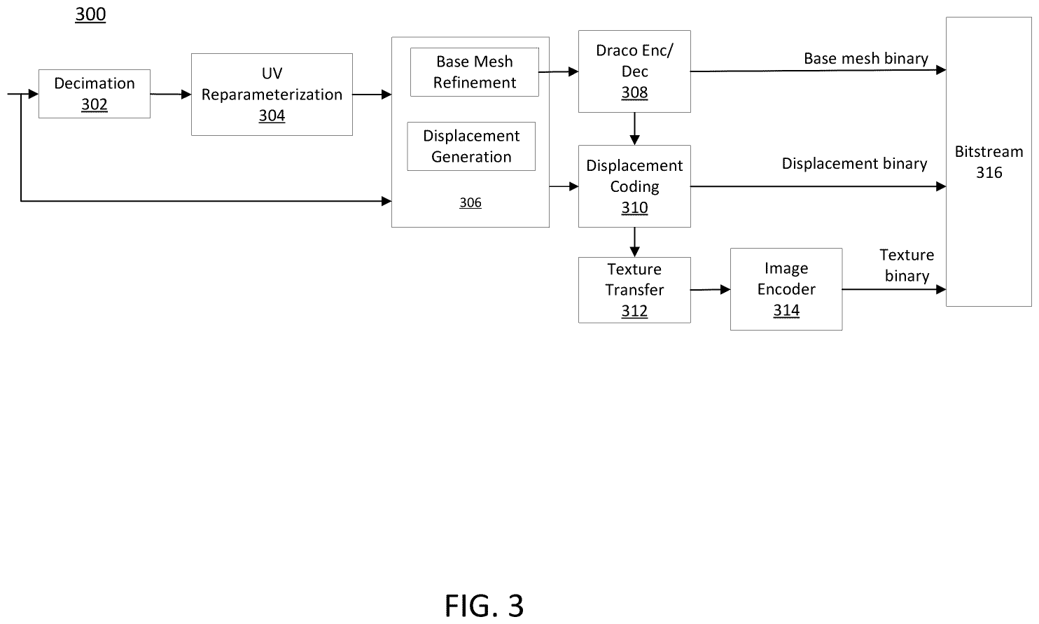

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

In one or more examples, a displacement is the residual vector between the interpolated midpoint and the corresponding position on the surface mesh as:

$${d}_{0} = pos - {pos}_{0} , \qquad Eq . ( 1 )$$

where the pos0 is the approximated position in the surface of the original mesh, and pos is the predicted position which is often the middle point.

In one or more examples, a displacement is further processed with a lifting transform. The prediction process may be defined as follows:

$$Signal ( v ) ← Signal ( v ) - \frac{1}{2} ( Signal ( {v}_{1} ) + Signal ( {v}_{2} ) ) , \qquad Eq . ( 2 )$$

where (i) v is the vertex introduced in the middle of the edge (v₁, v₂), and (ii) Signal(v), Signal(v₁), and Signal(v₂) are the values of the geometry/vertex attribute signals at the vertices v, v₁, and v₂, respectively.

In one or more examples, the update process may be defined as follows:

$$Signal ( v ) ← Signal ( v ) + \frac{1}{8} {\sum }_{w ∈ {v}^{*}} Signal ( w ) , \qquad Eq . ( 3 )$$

where v* is the set of neighboring vertices of the vertex v.

The scheme allows it to skip the update process. The wavelet coefficients may be quantized by using a uniform quantizer with a dead zone.

In one or more examples, the best prediction modes from a prediction set are signaled. The vertex may be processed by each connected component followed by the morton vertex order. Therefore, the assumption of an initial encoded vertex may be similar to the initial vertex of the previous encoded connected component.

Therefore, prediction set is adaptively selected corresponding to the number of encoded reference, as depicted in Table 1 for a given mesh with current connected component k-th. σ_{first}(k) denotes the index of first vertex in the k-th connected component. The details are:
For zero reference, there are up to four candidates with Pred0 is always P(0).
For one and two reference, there is only one candidate
For three references and six reference, single-way prediction and multi-way prediction more prediction mode are considered and signaled.

In one or more examples, a set of the previous encoded initial vertex are put to a cache C for future prediction, such as:

$$C = [ {σ}_{first} ( 0 ) , {σ}_{first} ( 1 ) , … , {σ}_{first} ( M - 1 ) ] , \qquad Eq . ( 4 )$$

where M denotes the cache size.

TABLE 1

| | |
|---|---|
| R0 | Pred0 = P(0) |
| | Pred1 = P(σ_{first}(1)) |
| | Pred2 = P(σ_{first}(2)) |
| | Pred3 = P(σ_{first}(M − 1)) |
| R1 | Pred = P(a0) |
| R2 | $Pred = \frac{P ( a 0 ) + P ( b 0 )}{2}$ |
| R3 | $SPred 0 = \frac{1}{2} ( P ( a 0 ) + 2 P ( b 0 ) - P ( c 0 ) )$ |
| | $SPred 1 = \frac{1}{32} ( 24 P ( a 0 ) + 29 P ( b 0 ) - 21 P ( c 0 ) )$ |
| | $SPred 2 = \frac{1}{32} ( 14 P ( a 0 ) + 23 P ( b 0 ) - 5 P ( c 0 ) )$ |
| | $SPred 3 = \frac{P ( a 0 ) + P ( b 0 )}{2}$ |
| | SPred4 = P(a0) + P(b0) − P(c0) |
| | SPred5 = P(b0) |
| | SPred6 = P(a0) |
| R6 | $MPred 0 = \frac{1}{32} ( 2 ( P ( a 0 ) + P ( a 1 ) ) + 20 ( P ( b 0 ) + P ( b 1 ) ) - 6 ( P ( c 0 ) + P ( c 1 ) ) )$ |
| | $MPred 1 = \frac{1}{32} ( 4 ( P ( a 0 ) + P ( a 1 ) ) + 21 ( P ( b 0 ) + P ( b 1 ) ) - 9 ( P ( c 0 ) + P ( c 1 ) ) )$ |
| | $MPred 2 = \frac{1}{32} ( 11 ( P ( a 0 ) + P ( a 1 ) ) + 18 ( P ( b 0 ) + P ( b 1 ) ) - 13 ( P ( c 0 ) + P ( c 1 ) ) )$ |
| | $MPred 3 = \frac{1}{32} ( 5 ( P ( a 0 ) + P ( a 1 ) ) + 18 ( P ( b 0 ) + P ( b 1 ) ) - 7 ( P ( c 0 ) + P ( c 1 ) ) )$ |
| | $MPred 4 = \frac{1}{32} ( ( P ( a 0 ) + P ( a 1 ) ) + 22 ( P ( b 0 ) + P ( b 1 ) ) - 7 ( P ( c 0 ) + P ( c 1 ) ) )$ |
| | $MPred 5 = \frac{1}{2} ( P ( b 0 ) + P ( b 1 ) )$ |
| | $MPred 6 = \frac{1}{32} ( 6 ( P ( a 0 ) + P ( a 1 ) ) + 21 ( P ( b 0 ) + P ( b 1 ) ) - 11 ( P ( c 0 ) + P ( c 1 ) ) )$ |
| | $MPred 7 = \frac{1}{2} ( ( P ( a 0 ) + P ( a 1 ) ) + ( P ( b 0 ) + P ( b 1 ) ) - ( P ( c 0 ) + P ( c 1 ) ) )$ |
| | $MPred 8 = - \frac{1}{2} ( P ( a 0 ) + P ( a 1 ) ) + P ( b 0 ) + P ( b 1 )$ |
| | MPred9 = P(a0) + P(b0) − P(c0) |
| | MPred10= P(a1) + P(b1) − P(c1) |

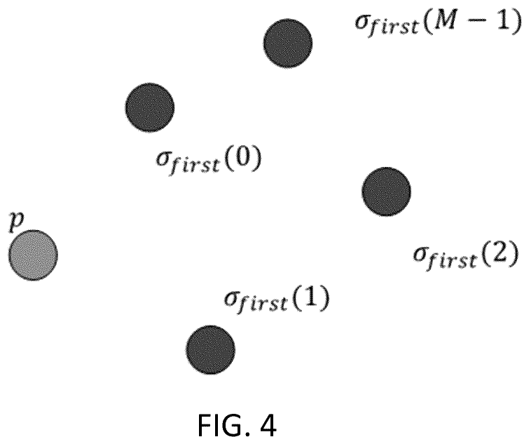

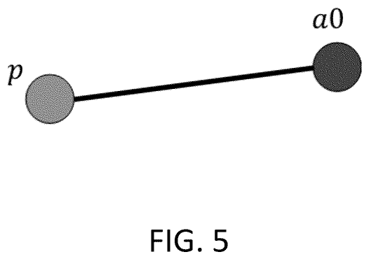

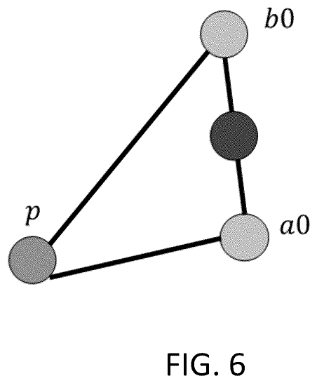

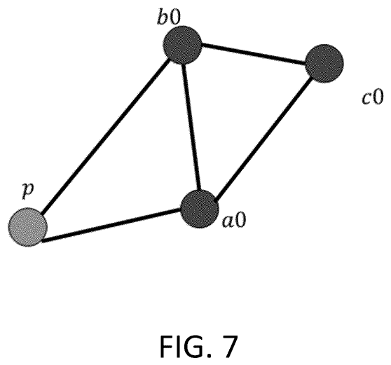

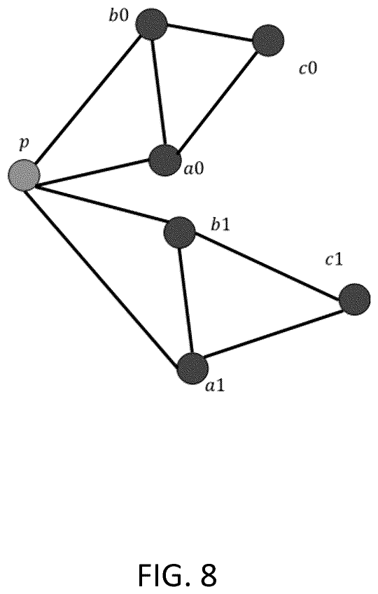

FIG. 4 illustrates example vertex positions of zero reference vertices (R0). FIG. 5 illustrates example vertex positions for one reference vertex (R1). FIG. 6 illustrates example vertex positions for two reference vertices (R2). FIG. 7 illustrates example vertex positions for three reference vertices (R3). FIG. 8 illustrates example vertex positions for six reference vertices (R6), in accordance with embodiments of the present disclosure.

After the best prediction mode is selected via a rate estimation process, the predictor index is signaled together with the residual between predicted and original position. In practice, only 8 previous encoded initial vertex position are stored. For a higher number of reference like three or six, single-way and multi-way prediction are introduced with adaptive selection set of 4 prediction modes as:
Single-way prediction
   Mode0={SPred0, SPred4, SPred5, SPred6}
   Mode1={SPred1, SPred4, SPred5, SPred6}
   Mode2={SPred2, SPred4, SPred5, SPred6}
   Mode3={SPred3, SPred4, SPred5, SPred6}
Multi-way prediction
   Mode0={MPred0, SPred8, SPred9, SPred10}
   Mode1={MPred1, SPred8, SPred9, SPred10}
   Mode2={MPred2, SPred8, SPred9, SPred10}
   Mode3={MPred3, SPred8, SPred9, SPred10}
   Mode4={MPred4, SPred8, SPred9, SPred10}
   Mode5={MPred5, SPred8, SPred9, SPred10}
   Mode6={MPred6, SPred8, SPred9, SPred10}
   Mode7={MPred7, SPred8, SPred9, SPred10}

The lifting transform can effectively reduce residual information in displacement at higher level of details (i.e., greater than 0) with the middle point prediction. At level 0, or base mesh level, there is no prediction to reduce the redundancy between neighboring displacements.

The embodiments of the present disclosure may be applied to any refinement information and may be used separately or in combination of any forms.

According to one or more embodiments, displacements at level of details 0 are encoded differently than the conventional method. Displacement at level of details 0 may be predicted and encoded by utilizing neighboring information.

According to one or more embodiments, a similar prediction architecture of position prediction for position coding is used. The encoding sequence may follow the vertex positioning order, with displacements predicted from previously encoded data using various predictors. The predictor candidates may be similar to those used in vertex prediction coding.

According to one or more embodiments, different sets of predictors are proposed for predict displacement with different reference. D(x) stands for displacement at position x, D(0) represent zero displacement.

TABLE 2

| | |
|---|---|
| R0 | Pred0 = D(0) |
| | Pred1 = D(σ_{first}(1)) |
| | Pred2 = D(σ_{first}(2)) |
| | Pred3 = D(σ_{first}(M − 1)) |
| R1 | Pred0 = D(a0) |
| | Pred1 = D(0) |
| R2 | $Pred 0 = \frac{1}{2} ( D ( a 0 ) + D ( b 0 ) )$ |
| | Pred1 = D(a0) |
| | Pred2 = D(b0) |
| | Pred3 = D(0) |
| R3 | $SPred 0 = \frac{1}{3} ( D ( a 0 ) + D ( b 0 ) + D ( c 0 ) )$ |
| | $SPred 1 = \frac{1}{2} ( D ( a 0 ) + D ( b 0 ) )$ |
| | $SPred 2 = \frac{1}{2} ( D ( a 0 ) + D ( c 0 ) )$ |
| | $SPred 3 = \frac{1}{2} ( D ( b 0 ) + D ( c 0 )$ |
| | SPred4 = D(b0) |
| | SPred5 = D(a0) |
| | SPred6 = D(0) |
| R6 | $MPred 0 = \frac{1}{6} ( D ( a 0 ) + D ( b 0 ) + D ( c 0 ) + D ( a 1 ) + D ( b 1 ) + D ( c 1 ) )$ |
| | $MPred 1 = \frac{1}{3} ( D ( a 0 ) + D ( b 0 ) + D ( c 0 ) )$ |
| | $MPred 2 = \frac{1}{3} ( D ( a 0 ) + D ( b 0 ) + D ( c 0 ) )$ |
| | $MPred 3 = \frac{1}{4} ( D ( a 0 ) + D ( b 0 ) + D ( a 1 ) + D ( b 1 ) )$ |
| | $MPred 4 = \frac{1}{2} ( D ( a 0 ) + D ( b 1 ) )$ |
| | $MPred 5 = \frac{1}{2} ( D ( a 0 ) + D ( b 0 ) )$ |
| | $MPred 6 = \frac{1}{2} ( D ( a 1 ) + D ( b 1 ) )$ |
| | MPred7 = D(b1) |
| | MPred8 = D(a0) |
| | MPred9 = D(0) |

The optimal predictor mode is indicated within the bitstream, optimizing the encoding process based on the context with single and multiple way prediction as follows:
Single-way prediction
   Mode0={SPred0, SPred4, SPred5, SPred6}
   Mode1={SPred1, SPred4, SPred5, SPred6}
   Mode2={SPred2, SPred4, SPred5, SPred6}
   Mode3={SPred3, SPred4, SPred5, SPred6}
Multi-way prediction
   Mode0={MPred0, MPred7, MPred8, MPred9}
   Mode1={MPred1, MPred7, MPred8, MPred9}
   Mode2={MPred2, MPred7, MPred8, MPred9}
   Mode3={MPred3, MPred7, MPred8, MPred9}
   Mode4={MPred4, MPred7, MPred8, MPred9}
   Mode5={MPred5, MPred7, MPred8, MPred9}
   Mode6={MPred6, MPred7, MPred8, MPred9}

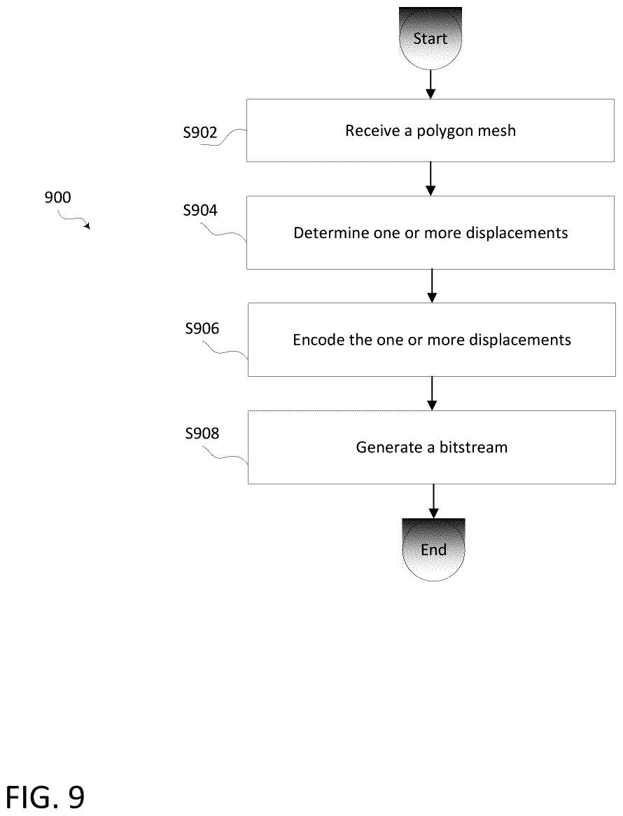

FIG. 9 is a flowchart of an example process 900 for determining displacements for a vertex in a polygon mesh. The process 900 may be performed by the encoder 203 (FIG. 2).

The process may start at operation S902 where a polygon mesh comprising a plurality of vertices is retrieved.

The process proceeds to operation S904 where one or more displacement vertices are determined. The number of displacement vertices may be determined based on a number of reference vertices such as R0 (FIG. 4), R1 (FIG. 5), R2 (FIG. 6), R3 (FIG. 7), and R6 (FIG. 8).

The process proceeds to operation S906 where the one or more displacements ae encoded. The process proceeds to operation S908 where the bitstream is generated. When the number of reference vertices is 3 or greater (e.g., R3 or R6), the bitstream may include a first indicated indicating a mode to be selected and a second indicator indicating a displacement from the mode to be used. For example, when the number of reference vertices is 3, the first indicator may indicate Mode0 and the second indicator may indicate to use the second displacement in Mode0 (e.g., SPred4)

A decoding process may be performed by the decoder 210. The decoder 210 may receive a bitstream including an encoded polygon mesh comprising a plurality of vertices and one or more encoded displacements. The decoder 210 may determine determining an encoded displacement from the one or more encoded displacements. The decoder 210 may decode the encoded displacement to generate a decoded displacement. The decoder 210 may decode a vertex from the plurality of vertices at a base level of the polygon mesh using the decoded displacement and one or more reference vertices from the plurality of vertices. The bitstream may include the first indicator and the second indicator for selecting a mode, and a particular displacement in the mode.

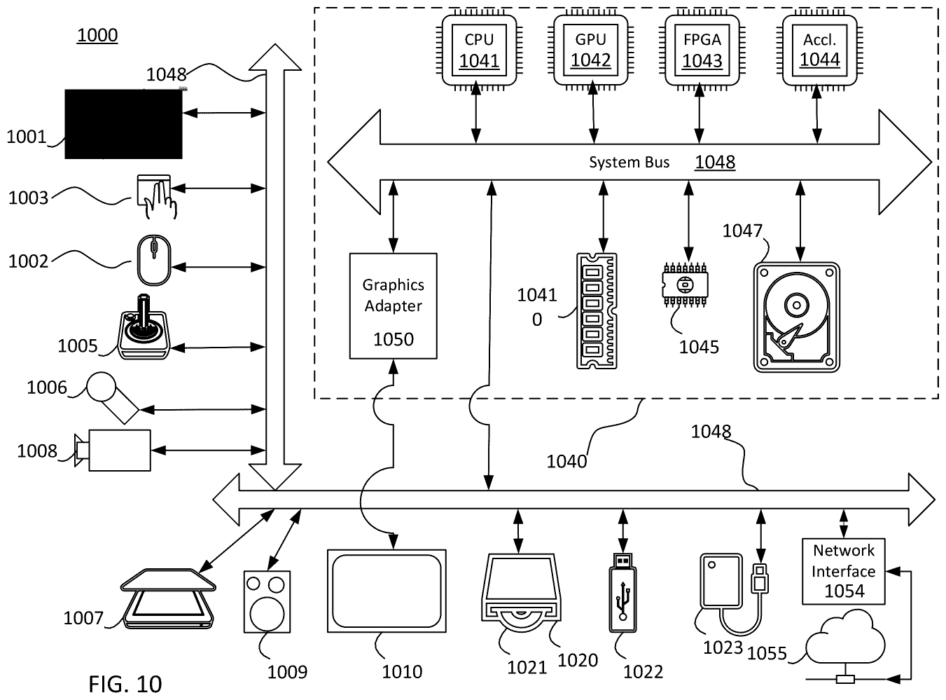

The techniques, described above, may be implemented as computer software using computer-readable instructions and physically stored in one or more computer-readable media. For example, FIG. 10 shows a computer system 1000 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 10 for computer system 1000 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1000.

Computer system 1000 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1001, mouse 1002, trackpad 1003, touch screen 1010, data-glove, joystick 1005, microphone 1006, scanner 1007, camera 1008.

Computer system 1000 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1010, data glove, or joystick 1005, but there may also be tactile feedback devices that do not serve as input devices). For example, such devices may be audio output devices (such as: speakers 1009, headphones (not depicted)), visual output devices (such as screens 1010 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1000 may also include human accessible storage devices and their associated media such as optical media including CD/DVD ROM/RW 1020 with CD/DVD or the like media 1021, thumb-drive 1022, removable hard drive or solid state drive 1023, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1000 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 1049 (such as, for example USB ports of the computer system 1000; others are commonly integrated into the core of the computer system 1000 by attachment to a system bus as described below (for example Ethernet interface into a PC computer system or cellular network interface into a smartphone computer system). Using any of these networks, computer system 1000 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 1055. Certain protocols and protocol stacks may be used on each of those networks and network interfaces as described above.

Aforementioned human interface devices, human-accessible storage devices, and network interfaces 1054 may be attached to a core 1040 of the computer system 1000.

The core 1040 may include one or more Central Processing Units (CPU) 1041, Graphics Processing Units (GPU) 1042, specialized programmable processing units in the form of Field Programmable Gate Areas (FPGA) 1043, hardware accelerators for certain tasks 1044, and so forth. These devices, along with Read-only memory (ROM) 1045, Random-access memory 1046, internal mass storage such as internal non-user accessible hard drives, SSDs, and the like 1047, may be connected through a system bus 1048. In some computer systems, the system bus 1048 may be accessible in the form of one or more physical plugs to enable extensions by additional CPUs, GPU, and the like. The peripheral devices may be attached either directly to the core's system bus 1048, or through a peripheral bus 1049. Architectures for a peripheral bus include PCI, USB, and the like. A graphics adapter 1050 may be included in the core 1040.

CPUs 1041, GPUs 1042, FPGAs 1043, and accelerators 1044 may execute certain instructions that, in combination, may make up the aforementioned computer code. That computer code may be stored in ROM 1045 or RAM 1046. Transitional data may be also be stored in RAM 1046, whereas permanent data may be stored for example, in the internal mass storage 1047. Fast storage and retrieve to any of the memory devices may be enabled through the use of cache memory, that may be closely associated with one or more CPU 1041, GPU 1042, mass storage 1047, ROM 1045, RAM 1046, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 1000, and specifically the core 1040 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 1040 that are of non-transitory nature, such as core-internal mass storage 1047 or ROM 1045. The software implementing various embodiments of the present disclosure may be stored in such devices and executed by core 1040. A computer-readable medium may include one or more memory devices or chips, according to particular needs. The software may cause the core 1040 and specifically the processors therein (including CPU, GPU, FPGA, and the like) to execute particular processes or particular parts of particular processes described herein, including defining data structures stored in RAM 1046 and modifying such data structures according to the processes defined by the software. In addition or as an alternative, the computer system may provide functionality as a result of logic hardwired or otherwise embodied in a circuit (for example: accelerator 1044), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A method performed by at least one processor of an encoder; the method including: receiving a polygon mesh including a plurality of vertices; determining, for a vertex from the plurality of vertices at a base level of the polygon mesh, one or more displacements between the vertex and one or more reference vertices from the plurality of vertices; encoding the one or more displacements; and generating a bitstream including the one or more encoded displacements and at least one of the one or more reference vertices.

(2) The method according to feature (1), in which the one or more reference vertices include a plurality of reference vertices that are not connected to the vertex, and in which the one or more displacements include a displacement between the vertex and each reference vertex from the plurality of reference vertices.

(3) The method according to feature (1), in which the one or more reference vertices include at least one reference vertex connected to the vertex, and the one or more displacements include a displacement between the vertex and the at least one reference vertex and a zero displacement.

(4) The method according to feature (1), in which the one or more reference vertices include a first reference vertex and a second reference vertex, in which the first reference vertex and the second reference vertex are connected to the vertex, and in which the one or more displacements include a displacement between the first reference vertex and the vertex, a displacement between the second reference vertex and the vertex, a displacement between an interpolated vertex between the first reference vertex and the second reference vertex and the vertex, and a zero displacement.

(5) The method according to feature (1), in which the one or more reference vertices include at least a first reference vertex, a second reference vertex, and a reference third vertex, in which the first reference vertex, the second reference vertex, and the third reference vertex are connected to the vertex.

(6) The method according to feature (5), in which the bitstream includes a first indicator that indicates one of a plurality of modes, each mode including a plurality of displacements from the determined one or more displacements.

(7) The method according to feature (6), in which the bitstream includes a second indicator that indicates a displacement from the plurality of displacements of the one of the plurality of modes.

(8) The method according to feature (7), in which the plurality of displacements of each mode includes at least (i) a zero displacement, (ii) a displacement between one of the first reference vertex, the second reference vertex, and the third reference vertex, and (iii) an interpolated vertex between one of the first reference vertex, the second reference vertex, and the third reference vertex.

(9) A method performed by at least one decoder, the method including receiving a bitstream including an encoded polygon mesh including a plurality of vertices and one or more encoded displacements; determining an encoded displacement from the one or more encoded displacements; decoding the encoded displacement to generate a decoded displacement; and decoding a vertex from the plurality of vertices at a base level of the polygon mesh using the decoded displacement and one or more reference vertices from the plurality of vertices.

(10) The method according to feature (9), in which the one or more reference vertices include a plurality of reference vertices that are not connected to the vertex, and in which the one or more encoded displacements include a displacement between the vertex and each reference vertex from the plurality of reference vertices.

(11) The method according to feature (9), in which the one or more reference vertices include at least one reference vertex connected to the vertex, and the one or more encoded displacements include a displacement between the vertex and the at least one reference vertex and a zero displacement.

(12) The method according to feature (9), in which the one or more reference vertices include a first reference vertex and a second reference vertex, in which the first reference vertex and the second reference vertex are connected to the vertex, and in which the one or more encoded displacements include a displacement between the first reference vertex and the vertex, a displacement between the second reference vertex and the vertex, a displacement between an interpolated vertex between the first reference vertex and the second reference vertex and the vertex, and a zero displacement.

(13) The method according to feature (9), in which the one or more reference vertices include at least a first reference vertex, a second reference vertex, and a reference third vertex, in which the first reference vertex, the second reference vertex, and the third reference vertex are connected to the vertex.

(14) The method according to feature (13), in which the bitstream includes a first indicator that indicates one of a plurality of modes, each mode including a plurality of encoded displacements from the one or more encoded displacements.

(15) The method according to feature (14), in which the bitstream includes a second indicator that indicates the encoded displacement from the plurality of encoded displacements of the one of the plurality of modes.

(16) The method according to feature (15), in which the plurality of displacements of each mode includes at least (i) a zero displacement, (ii) a displacement between one of the first reference vertex, the second reference vertex, and the third reference vertex, and (iii) an interpolated vertex between one of the first reference vertex, the second reference vertex, and the third reference vertex.

(17) A method performed by at least one processor of an encoder; the method including: generating a bitstream including a polygon mesh including a plurality of vertices; in which, for a vertex from the plurality of vertices at a base level of the polygon mesh, one or more displacements between the vertex and one or more reference vertices are determined, in which the one or more displacements are encoded; and in which the bitstream includes the one or more encoded displacements and at least one of the one or more reference vertices.

(18) The method according to feature (17), in which the one or more reference vertices include a plurality of reference vertices that are not connected to the vertex, and in which the one or more displacements include a displacement between the vertex and each reference vertex from the plurality of reference vertices.

(19) The method according to feature (17), in which the one or more reference vertices include at least one reference vertex connected to the vertex, and the one or more displacements include a displacement between the vertex and the at least one reference vertex and a zero displacement.

(20) The method according to feature (17), in which the one or more reference vertices include a first reference vertex and a second reference vertex, in which the first reference vertex and the second reference vertex are connected to the vertex, and in which the one or more displacements include a displacement between the first reference vertex and the vertex, a displacement between the second reference vertex and the vertex, a displacement between an interpolated vertex between the first reference vertex and the second reference vertex and the vertex, and a zero displacement.

What is claimed is:

1. A method performed by at least one processor of an encoder; the method comprising:
receiving a polygon mesh comprising a plurality of vertices;
determining, for a vertex from the plurality of vertices at a base level of the polygon mesh, one or more displacements between the vertex and one or more reference vertices from the plurality of vertices;
encoding the one or more displacements; and
generating a bitstream comprising the one or more encoded displacements and at least one of the one or more reference vertices.

2. The method according to claim 1, wherein the one or more reference vertices comprise a plurality of reference vertices that are not connected to the vertex, and wherein the one or more displacements comprise a displacement between the vertex and each reference vertex from the plurality of reference vertices.

3. The method according to claim 1, wherein the one or more reference vertices comprise at least one reference vertex connected to the vertex, and the one or more displacements comprise a displacement between the vertex and the at least one reference vertex and a zero displacement.

4. The method according to claim 1, wherein the one or more reference vertices comprise a first reference vertex and a second reference vertex, wherein the first reference vertex and the second reference vertex are connected to the vertex, and wherein the one or more displacements comprise a displacement between the first reference vertex and the vertex, a displacement between the second reference vertex and the vertex, a displacement between an interpolated vertex between the first reference vertex and the second reference vertex and the vertex, and a zero displacement.

5. The method according to claim 1, wherein the one or more reference vertices comprise at least a first reference vertex, a second reference vertex, and a reference third vertex, wherein the first reference vertex, the second reference vertex, and the third reference vertex are connected to the vertex.

6. The method according to claim 5, wherein the bitstream includes a first indicator that indicates one of a plurality of modes, each mode comprising a plurality of displacements from the determined one or more displacements.

7. The method according to claim 6, wherein the bitstream includes a second indicator that indicates a displacement from the plurality of displacements of the one of the plurality of modes.

8. The method according to claim 7, wherein the plurality of displacements of each mode comprises at least (i) a zero displacement, (ii) a displacement between one of the first reference vertex, the second reference vertex, and the third reference vertex, and (iii) an interpolated vertex between one of the first reference vertex, the second reference vertex, and the third reference vertex.

9. A method performed by at least one decoder,
receiving a bitstream comprising an encoded polygon mesh comprising a plurality of vertices and one or more encoded displacements;
determining an encoded displacement from the one or more encoded displacements;
decoding the encoded displacement to generate a decoded displacement; and
decoding a vertex from the plurality of vertices at a base level of the polygon mesh using the decoded displacement and one or more reference vertices from the plurality of vertices.

10. The method according to claim 9, wherein the one or more reference vertices comprise a plurality of reference vertices that are not connected to the vertex, and wherein the one or more encoded displacements comprise a displacement between the vertex and each reference vertex from the plurality of reference vertices.

11. The method according to claim 9, wherein the one or more reference vertices comprise at least one reference vertex connected to the vertex, and the one or more encoded displacements comprise a displacement between the vertex and the at least one reference vertex and a zero displacement.

12. The method according to claim 9, wherein the one or more reference vertices comprise a first reference vertex and a second reference vertex, wherein the first reference vertex and the second reference vertex are connected to the vertex, and wherein the one or more encoded displacements comprise a displacement between the first reference vertex and the vertex, a displacement between the second reference vertex and the vertex, a displacement between an interpolated vertex between the first reference vertex and the second reference vertex and the vertex, and a zero displacement.

13. The method according to claim 9, wherein the one or more reference vertices comprise at least a first reference vertex, a second reference vertex, and a reference third vertex, wherein the first reference vertex, the second reference vertex, and the third reference vertex are connected to the vertex.

14. The method according to claim 13, wherein the bitstream includes a first indicator that indicates one of a plurality of modes, each mode comprising a plurality of encoded displacements from the one or more encoded displacements.

15. The method according to claim 14, wherein the bitstream includes a second indicator that indicates the encoded displacement from the plurality of encoded displacements of the one of the plurality of modes.

16. The method according to claim 15, wherein the plurality of displacements of each mode comprises at least (i) a zero displacement, (ii) a displacement between one of the first reference vertex, the second reference vertex, and the third reference vertex, and (iii) an interpolated vertex between one of the first reference vertex, the second reference vertex, and the third reference vertex.

17. A method performed by at least one processor of an encoder; the method comprising:
generating a bitstream comprising a polygon mesh comprising a plurality of vertices;
wherein, for a vertex from the plurality of vertices at a base level of the polygon mesh, one or more displacements between the vertex and one or more reference vertices are determined,
wherein the one or more displacements are encoded; and
wherein the bitstream comprises the one or more encoded displacements and at least one of the one or more reference vertices.

18. The method according to claim 17, wherein the one or more reference vertices comprise a plurality of reference vertices that are not connected to the vertex, and wherein the one or more displacements comprise a displacement between the vertex and each reference vertex from the plurality of reference vertices.

19. The method according to claim 17, wherein the one or more reference vertices comprise at least one reference vertex connected to the vertex, and the one or more displacements comprise a displacement between the vertex and the at least one reference vertex and a zero displacement.

20. The method according to claim 17, wherein the one or more reference vertices comprise a first reference vertex and a second reference vertex, wherein the first reference vertex and the second reference vertex are connected to the vertex, and wherein the one or more displacements comprise a displacement between the first reference vertex and the vertex, a displacement between the second reference vertex and the vertex, a displacement between an interpolated vertex between the first reference vertex and the second reference vertex and the vertex, and a zero displacement.
